(19) United States
(12) Patent Application Publication
(10) Pub. No.: US 2009/0214357 A1
(43) Pub. Date: Aug. 27, 2009

(54) Variable speed drive for progressing cavity pumps

(76) Inventor: Serge V. Galley, Katy, TX (US)

Correspondence Address: Aleksandr Smushkovich, POB 140505, Brooklyn, NY, 11214, US

(21) Appl. No.: 12/072,181

(22) Filed: Feb. 25, 2008

(51) Int. Cl. F04B 49/00; F04B 17/00; F16H 9/00

(52) U.S. Cl. 417/44.1; 417/362; 474/83

(57) ABSTRACT

A variable speed drive for RPM control of a revolvable device, preferably a progressing cavity pump, is proposed. It comprises parallel driving and driven shafts, coupled respectively to a first and second substantially identical cone-shaped rotors, situated in inverse positions to each other; an elastic belt, stretchably placed around the rotors, forming a left branch, a right branch, and curved sections frictionally coupled with the rotors; and a speed control means, capable to displace the left branch upward or alternatively to displace the right branch downward, causing corresponding displacements of the belt, changing the transmission ratio, thereby controlling the RPM of the rotatable device, in some embodiments—automatically. Known materials, parts, and inexpensive technologies can be utilized in the drive, and can be manufactured, e.g., by establishments in the oil equipment and machinery industry, and thus can be efficient, cheap, reliable, and convenient for producers and users.

### FIELD OF THE INVENTION

The invention relates to gear and transmission devices. More specifically, it relates to devices capable of regulating the rotation speed (rounds-per-minute, or RPM) of progressive cavity pumps mainly utilized for pumping oil or gas from wells, though may find other useful applications in various gear mechanisms, etc.

### BACKGROUND OF THE INVENTION

A progressive cavity pump is also known as a progressing cavity pump, eccentric screw pump, or just cavity pump. This type of pump transfers fluid by means of a progressing sequence of small fixed-shape discrete cavities, as its rotor is turned. This leads to the volumetric fluid rate being proportional to the bidirectional rotation rate, and to the low-leveled shearing being applied to the pumped fluid.

Therefore, these pumps have application in fluid metering and pumping of viscous or shear sensitive materials. It should be noted that the cavities taper down towards their ends and overlap with their neighbors, so that no flow pulsing is generally caused by the arrival of the cavities at the outlet of the pump, other than pulsing caused by compression of the fluid or other pump components.

The principles of this pumping technique is frequently misunderstood. Often it is believed to occur due to a dynamic effect caused by drag, or friction against the moving teeth of the screw rotor. However, in reality, it is due to sealed cavities, like a piston pump, and so has similar operational characteristics, such as being able to pump at extremely low rates, even to high pressure, revealing the effect to be a purely positive displacement.

The progressive cavity type pumps need a fundamentally different understanding than the types to which people are more commonly first introduced, namely the ones that can be thought of as generating pressure. This can lead to the mistaken assumption that all pumps can have their flow rates adjusted by using a valve attached to their outlet.

This assumption applied to the progressive pumps creates a problem, since such a valve has practically no effect on the flow rate, and when being sharply and completely shut off will generate high and probably damaging pressure. In order to prevent this, the pumps are often fitted with cutoff pressure switches, or burst disks (deliberately weak and easily replaceable points).

In the oil industry, where progressive cavity pumps are extensively used in conjunction with oil wells, it is necessary to vary the flow rate that is unique for each well, without damaging the pump or creating other problems.

In the prior art, there are known a number of types of devices capable to vary the RPM of the pumps. A majority of pumps are powered with electrical motors that typically have a very high rotational speed. In order to reduce the speed, a variety of means have been proposed. The most commonly used approaches of such variable regulation are the following:

(A) The pump's rotor is connected to a pulley by a rubber belt (pulley transmission) that provides a limited RPM range. The pulley transmission cannot gradually control the RPM. Usually, an operator should physically go to the well and stop the pump to connect (change) a pulley of the right diameter.

(B) A hydraulic drive is utilized, which is efficient, but highly expensive (it currently costs about $20000).

(C) A variable frequency drive is deployed for regulating the RPM of the motor that is also expensive (it currently costs about $8000). Some examples of devices controlling the RPM of pumps are described herein below.

One such example is taught in U.S. Pat. No. 4,973,226, incorporated herein by reference: “A method of maintaining a substantially constant amount of filling of a liquid well pump actuated by a polished rod which is reciprocated by a prime mover. The load and position of the polished rod is periodically measured to determine the amount of filling of the pump. The change in the amount of filling of the pump of one pumping cycle relative to a previous pumping cycle is compared and the speed of actuation of the pump is varied as a function of the change in the amount of filling of the pump to maintain a substantially constant amount of filling of the pump. The pump is continuously actuated but the speed is varied for preventing the well from being pumped dry.” The variation of speed is provided by a “variable speed power unit” mentioned in general terms.

U.S. Pat. No. 5,044,888 describes “A variable speed pump control system and method which senses operational parameters during the first one half of the down stroke to control pump speed to maximize production. The method and equipment maintains the fluid level of a well as low as possible while avoiding the pump-off condition. A variable speed motor drives a pump jack and a control means varies the pump speed. Means are provided for simultaneously sensing the pump speed, load on the rod, and the position of the rod in the pump stroke. These measurements are utilized to calculate the power transferred between the rod string and the beam during a portion of the downstroke. Before the pump is continuously operated, a series of measurements are made in the full barrel pumping condition to determine the power transferred between the rod and beam at various speeds. These are utilized to establish a relationship between pump speed and power during a portion of the downstroke. The well is operated and the measured values obtained during pumping are compared to the established relationship between pump speed and power. The pump speed is varied according the established relationship to power to optimize the fluid level in the well.” However, there is no specific structure of the ‘variable speed drive’ disclosed in the description and drawings of the mentioned patent.

Another U.S. Pat. No. 5,251,696 teaches “A method and apparatus for Varying the speed of operations of an oil well pumping unit powered by a motor wherein variations in oil viscosity may be efficiently accommodated. An oil well pumping unit which includes a submersible pump actuated by means of a reciprocating string of sucker rods is monitored for both rod position and load present on the sucker rods. The oil well pumping unit is driven by an electric or gas motor through a controllable coupling and the speed of the oil well pumping unit is then varied, utilizing the controllable coupling, in response to variations in sucker rod load. As the lowering of the sucker rod is impeded by high viscosity oil, the load on the sucker rod decreases. This decrease in sucker rod load is utilized to decrease the speed of the oil well pumping unit by means of the controllable coupling to ensure that bridle separation does not occur. Additionally, increases in sucker rod load above a preselected maximum may also be detected and utilized to slow the operation of the oil well pumping unit to prevent damage to the sucker rods.”

The structure of “contactor” and “slip ring” is deployed for coupling and de-coupling the V-belt sheave (pulley) assembly that effectively causes the variation of the pump's speed. “As V-belt sheave assembly 68 rotates, sheave 84 also rotates and is preferably utilized to drive multiple V-belts or other suitable drive mechanisms. The speed at which sheave 84 rotates is preferably controllable by detecting the rotation of marker 88 by means of sensor 86 in any manner well known in the art.” This is more or less a conventional regulative structure and method, resembling the approach-A.

Yet, U.S. Pat. No. 5,782,608 discloses “A method and apparatus for controlling the speed of a progressing cavity liquid well pump by driving the pump with a variable speed drive device while measuring the amount of liquid production from the pump. The speed of the pump is varied in speed steps, either upwardly or downwardly, by the variable speed drive device while measuring liquid production, to maintain a linear relationship between liquid production and pump speed.” As the above patent teaches, the variation of speed is provided by a variable frequency drive, i.e. electronically (aforesaid approach-C). As stated above, this kind of drive is significantly expensive. Pat. No. 5,782,608 does mention a ‘gear box’, but only as a general term, not providing any details on it.

### BRIEF SUMMARY OF THE INVENTION

The instant invention proposes a variable speed drive for RPM control of a revolvable device, preferably a progressing cavity pump, and comprises parallel driving and driven shafts, coupled respectively to a first and second substantially identical cone-shaped rotors, situated in inverse positions to each other; an elastic belt, stretchably placed around the rotors, forming a left branch, a right branch, and curved sections frictionally coupled with the rotors; and a speed control means, capable to displace the left branch upward or alternatively to displace the right branch downward, causing corresponding displacements of the belt, changing the transmission ratio, thereby controlling the RPM of the rotatable device, in some embodiments—automatically. The drive can utilize known materials, parts, and inexpensive technologies, and, e.g., be manufactured by establishments in the oil equipment and machinery industry, and thus can be efficient, cheap, reliable, and convenient for producers and users.

### PRINCIPLE DESCRIPTION OF THE INVENTION

All the aforementioned variable drive devices and many others include complicated structures and elements, hence, are expensive and demand qualified technical personnel to install and operate them.

The primary aim of the present invention is to provide a simple, cost effective, safe, reliable, and easily operable variable speed drive for gradual regulating the RPM of progressive cavity pumps, without the risk of damaging the pump, or creating other problems. Other aims of the invention will become apparent to those skilled in the art from a consideration of the drawings, ensuing description, and claims as hereinafter related.

The present invention enables regulating the RPM of the pump in a desirable manner, overcoming the explained-above drawbacks of the prior art devices, which is achieved by a special novel design and shapes of elements of the inventive device and their mutual dispositions.

The inventive variable drive can be merely made of suitable widely used materials and parts applying known inexpensive technologies. For instance, the inventive drives can be manufactured by establishments in the oil field equipment and machinery industry. Variable speed drive devices designed based on the invention thus can be efficient, cheap, reliable, and convenient for producers and users.

In a preferred embodiment, the inventive variable speed drive comprises a first and a second substantially identical pivotable transmission rotors, whose axes are aligned in parallel. The rotors are made fully conical or as truncated cones, and herein defined as ‘cone-shaped rotors’ or just ‘cone rotors’. The first rotor is fixedly mounted on a first shaft (or a driving shaft) preferably rotated by a conventional motor.

The second cone rotor is situated in a position inverse to the first rotor's position that is ‘upside down’. The vertex of the second cone rotor lies in the same plane with the base of the first cone rotor, and vise-versa.

In a preferred embodiment, the first shaft is pivotally mounted in a stationary frame including a necessary number of ribs. The motor is fixed to the frame and properly coupled to the first shaft. The frame, in turn, is fixed to the wellhead, which provides rigidity and a fixed distance between the axes of the cone rotors.

The second rotor is fixedly mounted on a second shaft (or a driven shaft). The first and second shafts are preferably vertically positioned, but alternatively may be disposed at a different angle to fit into a particular construction.

In a preferred embodiment, a polished rod, in turn rotating a rod (shaft) of a progressing cavity pump, can be deployed as the second shaft. In optional embodiments, a known intermediate gear can be utilized to transmit the rotation from the second shaft to a driven revolvable device.

The inventive variable speed drive comprises a speed control means or a speed control unit (SCU). In a preferred embodiment, the SCU employs a worm gear mechanism. In alternative embodiments, the SCU can utilize a rack gear, or other gear mechanisms suitable for converting various movements into straight displacement.

The worm gear mechanism includes a vertical screw-threaded gear shaft pivotally mounted in the frame. The worm gear mechanism includes a bushing with an internal screw-threaded through hole, revolvably associated with the gear shaft as a screw pair.

The SCU comprises a left (first) half-shaft and a right (second) half-shaft, which half-shafts are disposed in one plane with, and transversely to the vertical gear shaft. The inner ends of the left and the right half-shafts are fixedly coupled with the bushing. The free outer ends of the half-shafts are movably mounted on the frame, so that capable to slide along its corresponding ribs.

The SCU comprises a left (first) roll revolvably mounted on the left half-shaft, and a right (second) roll revolvably mounted on the right half-shaft. In a preferred embodiment, the rolls can be performed as conventional cylindrical ball-bearings of a suitable size, inner-fixed to the half-shafts.

The inventive variable speed drive comprises an elastic belt having a substantially constant length, preferably made of a suitable sort of rubber. The left and right rotors' axes are positioned in parallel, preferably vertically. The belt is stretchably placed around (looped over) the first and second cone rotors, so that forming a left straight branch and a right straight branch extending between the rotors, a first curved section frictionally coupled with the first rotor, and a second curved section frictionally coupled with the second rotor. Thusly, the belt is situated substantially in a plane perpendicular to the rotors' axes.

The left branch extends below the left roll and is brought into contact with it, applying an upward pressure to the left roll and experiencing a downward reaction pressure from the left roll. Correspondingly, the right branch extends above the right roll and is brought into contact with it, applying a downward pressure to the right roll and experiencing an upward reaction pressure from the right roll.

In the above-described embodiments, the half-shafts are situated substantially in one (preferably horizontal) level, that is essentially in the same plane, in which the belt is positioned. Thus the belt can be subjected to distortions. In alternative preferred embodiments, the left and right half-shafts can be situated in different (preferably horizontal) levels above and below the plane, in which the belt is positioned. The belt's left branch is disposed above the left roll, and the belt's right branch is disposed below the right roll, which will minimize or even eliminate such distortions.

The elastic forces of the belt are so directed that lead to maintaining a constant length of the belt. Therefore, in operation, the upward pressure applied to the right branch will cause an upward displacement of the belt so that the first and second curved sections will be situated substantially in the same plane above an initial position of the belt's plane. Analogously, the downward pressure applied to the left branch will cause a downward displacement of the belt so that the first and second curved sections will be situated substantially in the same plane below an initial position of the belt's plane.

The aforesaid upward or downward pressure applied to the belt's branches can be operatively created by straight (in this case, vertical) linear displacements of the rolls alternatively in one of two opposite directions. In a preferred embodiment, the displacements are caused by vertically moving the bushing of the worm gear mechanism, due to turning the gear shaft. Optionally, other mechanisms capable to displace the rolls in two opposite directions can be employed.

In a preferred embodiment, the turning of the gear shaft can be accomplished with a turning means, for example, an electrical servomotor remotely connected to an electric power source through a known voltage or current control device. Exemplarily, the servomotor can be designed as a step-motor.

Thus, the operator can remotely create a downward or upward displacement of the belt, changing the planes of the belt's disposition, causing changes of the ratio between the radiuses of the first curved section and the second curved section, thereby gradually controlling the transmission RPM ratio, i.e. respectively increasing or decreasing the RPM of the second rotor and the driven shaft in a smooth manner.

In some alternative embodiments, the speed of the motor can additionally be more precisely regulated by known means, whereas the SCU is used to gradually and smoothly alter the RPM transmission ratio of the cone rotors, thereby increasing and decreasing the rotational speed of the driven shaft as required.

Every oil producing well has unique fluid deliverability characteristics and requires thorough choosing production parameters. As stated above in U.S. Pat. No. 4,973,226: “The change in the amount of filling of the pump of one pumping cycle relative to a previous pumping cycle is compared and the speed of actuation of the pump is varied as a function of the change in the amount of filling of the pump to maintain a substantially constant amount of filling of the pump. The pump is continuously actuated but the speed is varied for preventing the well from being pumped dry.” It is therefore very important to enable the inventive device to control the pump's RPM according to real physical parameters of the pump operation.

Therefore, in some preferred embodiments of the inventive variable speed drive, it can be furnished with an automatic control unit (ACU) capable to support the optimum rate of production of the progressing cavity pump by varying its rotational speed, and to avoid a run of the pump in a ‘dry mode’.

For this purpose, a downhole pressure (physical parameter—Pi in pounds per square inch) at the bottom of the well is measured by a gauge that issues reading signals proportional to the measured downhole pressure. Three parameters are set (programmably or can be chosen by the operator) in the ACS: a) Pre-selected Sample Rate (SR) is a time interval between two sequential reading signals of the downhole pressure measured by the gauge, in minutes; SR has to be significant (from a few minutes to an hour or more), because the reservoir of fluid (mostly, oil saturated formation) will react slowly; b) Pre-selected Turn Steprate (TSR) is a rotational speed increment, predetermined for the particular well, in rounds per minute; c) Pre-selected (downhole) Pressure Threshold (PT) is a pressure for a fluid level above the progressing cavity pump, in pounds per square inch; PT must be restricted to provide safe operation of the pump.

The ACU implements the following algorithm. A first cycle starts upon receiving a first reading signal Pi from the gauge; the ACU compares it to the PT. If the downhole pressure Pi is equal to the PT, there is no further adjustment required and the pump operates with the optimal rotational speed. If the downhole pressure Pi is less than the PT, it is necessary to slow down the pump's rotational speed by the TSR. If the downhole pressure Pi is greater than the PT, it is necessary to increase the pump's rotational speed by the TSR. The next cycle commences from the receipt of the next Pi signal.

According to this algorithm, the ASU issues regulative signals to the servomotor, or another turning means deployed by the SCU for a particular embodiment of the inventive variable speed drive. The regulative signals will correspondingly cause necessary displacements of the rolls of the SCU, changing the transmission ratio of the inventive device, and thereby accelerating or decelerating the pump.

### BRIEF DESCRIPTION OF THE DRAWINGS

FIG. 1 illustrates an isometric view of the inventive variable drive associated with parts rotating a progressing cavity pump, according to an exemplary embodiment of the present invention.

FIG. 2 illustrates a more detail isometric view of a worm gear mechanism incorporated into the inventive variable drive, according to the exemplary embodiment of the present invention shown on FIG. 1.

FIG. 2a illustrates an isometric view, similar to the one shown on FIG. 2, but having the worm gear mechanism with half-shafts arranged in different horizontal levels.

FIG. 3 illustrates an isometric view of the inventive variable drive associated with parts rotating a progressing cavity pump, according to another exemplary embodiment of the present invention, including a servomotor and a gauge.

FIG. 4 is a flowchart illustrating the operation logic of an automatic control system regulating the rotational speed of the inventive variable drive, according to the exemplary embodiment of the present invention shown on FIG. 3.

Identical reference numerals in the drawings generally refer to the same elements in different figures. A first-time introduced numeral in the description is enclosed into parentheses.

### EXEMPLARY PREFERRED EMBODIMENTS OF THE INVENTION

While the invention may be susceptible to embodiment in different forms, there are shown in the drawings, and will be described in detail herein, specific exemplary embodiments of the present invention, with the understanding that the present disclosure is to be considered an exemplification of the principles of the invention, and is not intended to limit the invention to that as illustrated and described herein.

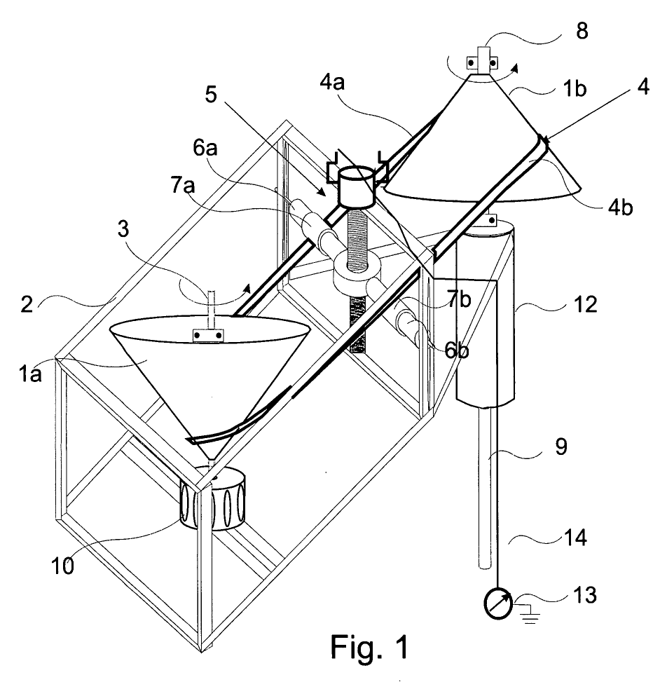

In the preferred embodiment exemplified on FIG. 1, the inventive variable speed drive for regulating the RPM of a progressing cavity pump comprises a first cone-shaped transmission rotor (1A) and a second cone-shaped transmission rotor (1B) substantially identical to the rotor 1A. The inventive drive comprises a first revolvable shaft (3) and a second revolvable shaft (8). The rotor 1A is fixedly mounted on the shaft 3, and the rotor 1B is fixedly mounted on the shaft 8. The shafts 3 and 8 are vertically positioned.

In this embodiment, the shaft 3 is driven by a conventional motor (10). The second shaft 8 is used as a polish rod essentially driving the progressing cavity pump. Namely, the rotation of the shaft 8 is passed through a wellhead (12) to the driving rod (9) of the pump.

The rotor 1B is situated in a position inverse to the position of rotor 1A. The vertex of rotor 1B lies in the same plane with the base of rotor 1A, and vise-versa.

In the preferred embodiment illustrated on FIG. 1, the shaft 3 is pivotally mounted in a stationary frame (2). The frame 2, in turn, is fixed to the wellhead 12. The motor 10 is fixed to the frame 2 and properly coupled to the shaft 3.

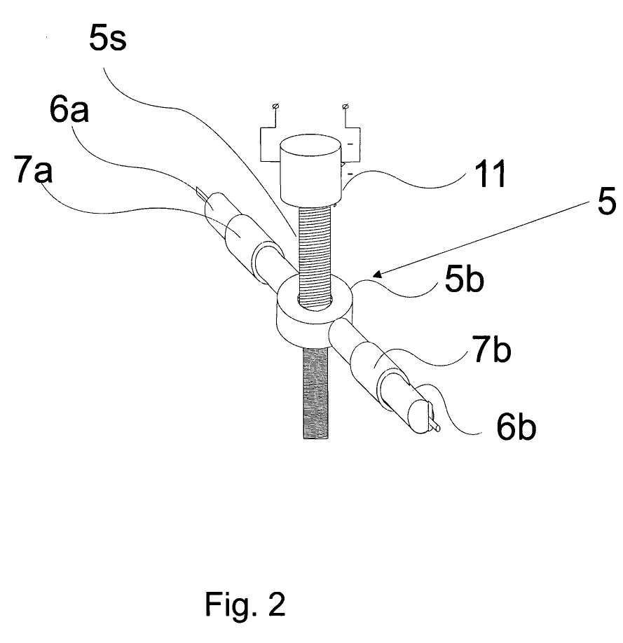

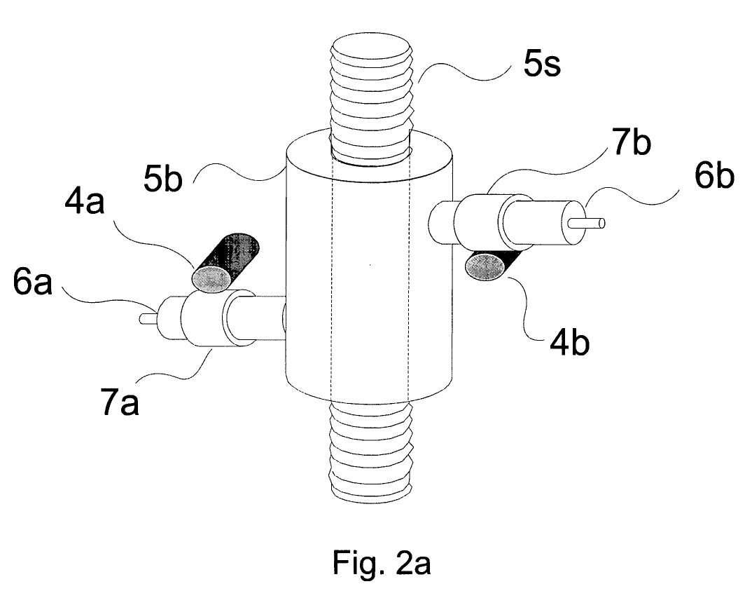

The inventive variable speed drive comprises a speed control unit (SCU), in this embodiment represented by a worm gear mechanism (5), also shown in more detail on FIG. 2. The mechanism 5 includes a vertical screw-threaded gear shaft (5S) pivotally mounted in the frame 2 (illustrated on FIG. 1). The mechanism 5 includes a bushing (5B) revolvably associated with the shaft 5S, as a screw pair.

The mechanism 5 comprises a left half-shaft (6a) and a right half-shaft (6b), disposed in one plane, and transversely to the shaft 5S. The inner ends of the half-shaft 6a and the half-shaft 6b are fixedly coupled with the bushing 5B. The free outer ends of the half-shafts 6a and 6b are movably mounted on the frame 2, so that capable to vertically slide along its corresponding ribs, as illustrated on FIG. 1.

The mechanism 5 comprises a left roll (7a) revolvably mounted on the half-shaft 6a, and a right roll (7b) revolvably mounted on the half-shaft 6b. The rolls 7a and 7b are performed as cylindrical ball-bearings, inner-fixed to the half-shafts 6a and 6b.

The inventive variable speed drive comprises an elastic belt (4) substantially having a constant length, preferably made of a suitable sort of rubber. The axes of rotors 1A and 1B are positioned vertically. The belt 4 is stretchably looped over the rotors 1A and 1B, so that forming a first (e.g. left) straight branch (4a) and a second (e.g. right) straight branch (4b), a first curved section frictionally coupled with the rotor 1A, and a second curved section frictionally coupled with the rotor 1B.

The branch 4a extends below the roll 7a and is brought into contact with it, applying an upward pressure thereon, and experiencing a downward reaction pressure therefrom. Correspondingly, the branch 4b extends above the roll 7b and is brought into contact with it, applying a downward pressure thereon, and experiencing an upward reaction pressure therefrom.

The aforesaid upward and downward pressure applied to the branches 4a and 4b is operatively created by vertical movements of the rolls 7a and 7b. The vertical movements are caused by moving the bushing 5B, due to turning the shaft 5S.

As disclosed above and illustrated on FIG. 2a, in alternative preferred embodiments, the left half-shaft 6a and right half-shaft 6b can be situated in different horizontal levels above and under the horizontal plane, in which the belt 4 is positioned. The belt's left branch 4a is disposed above the left roll 7a, and the belt's right branch 4b is disposed under the right roll 7b, which will minimize or even eliminate distortions that may appear during interactions between the belt and the right and left rolls.

As illustrated on FIG. 2, the turning of the shaft 5S is accomplished with an electrical servomotor (11) remotely connected to an electric power source through a known voltage or current control device (not illustrated). Such control device should be capable to change the speed and direction of rotation of the servomotor 11.

Through regulating the servomotor 11, the operator remotely creates the downward or upward displacement of the belt 4, thereby respectively gradually increasing or decreasing the RPM of the rotor 1B and the shaft 8 in a smooth manner, providing necessary control of rotational speed of the progressing cavity pump.

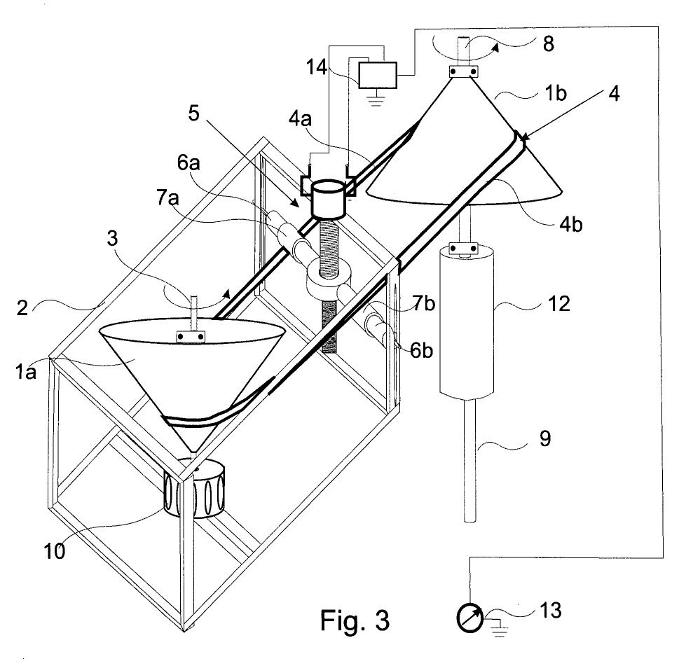

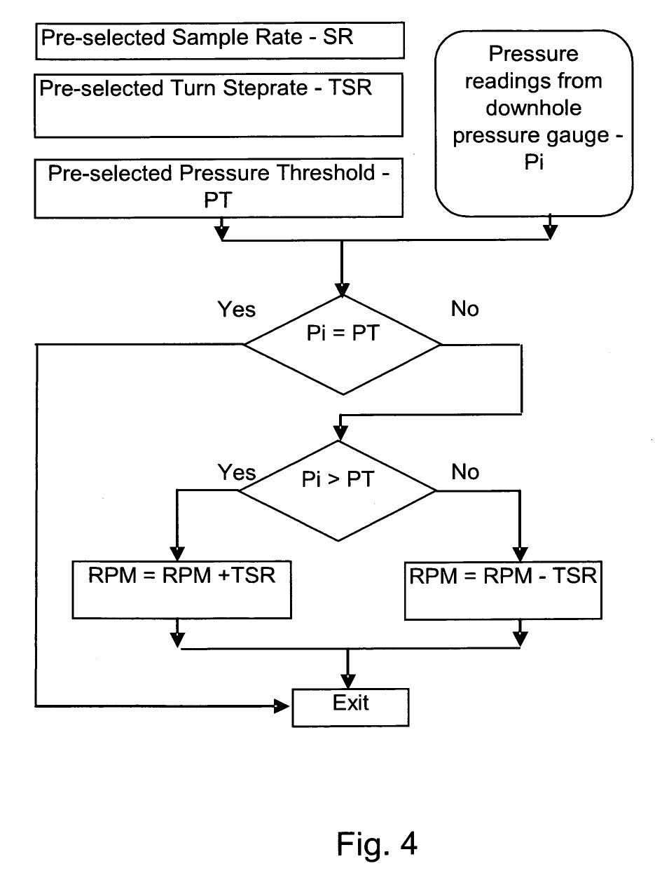

FIG. 3 shows another preferred embodiment of the inventive variable speed drive, additionally comprising a gauge (13) measuring the downhole pressure Pi at the bottom of the well, and an automatic control unit (ACU) (14) operating in accordance with the above-described algorithm, illustrated by the flowchart shown on FIG. 4.

The gauge 13 issues a reading signal, proportional to Pi, and transmits it to the ACU 14, which determines the difference between Pi and PT. If the difference is not zero, the ACU issues corresponding regulative signals, which turns the servomotor 11 in the required direction, causing necessary displacements of the rolls 7a and 7b that regulates the pump's RPM, as described above, with respect to these regulative signals. Such cycles repeat upon receiving each Pi signal from the gauge with the time intervals SR, predetermined as explained herein earlier.

I claim:

1. A variable speed drive for RPM control of a revolvable device comprising:
a pivotable driving shaft;
a pivotable driven shaft rotating the revolvable device, said driven shaft aligned in parallel to the driving shaft;
a first cone-shaped rotor mounted on the driving shaft;
a second cone-shaped rotor mounted on the driven shaft and substantially identical to the first rotor, said rotors situated in inverse positions to each other;
an elastic belt substantially having a constant length, stretchably placed around the first and second rotors, so that forming a left straight branch and a right straight branch, a first curved section frictionally coupled with the first rotor, and a second curved section frictionally coupled with the second rotor, said belt situated in a plane substantially perpendicular to the driving shaft and the driven shaft; and
a speed control means, capable to displace said left branch in a first direction or alternatively capable to displace said right branch in a second direction parallel and oppositely oriented to the first direction, causing corresponding displacements of said plane of the belt along the first direction or alternatively along the second direction, thereby controlling the RPM of the rotatable device.

2. A variable speed drive for RPM control of a progressing cavity pump comprising:
a frame mounted stationary in relation to the pump;
a motor means mounted on the frame;
a driving shaft pivotally mounted on the frame, and rotatable by the motor means;
a pivotable driven shaft essentially rotating the pump, said driven shaft aligned in parallel to the driving shaft;
a first cone-shaped rotor fixedly mounted on the driving shaft;
a second cone-shaped rotor, fixedly mounted on the driven shaft, and substantially identical to the first rotor, said rotors situated in inverse positions to each other;
an elastic belt, substantially having a constant length, and stretchably placed around the first and second rotors, so that forming a first straight branch and a second straight branch, a first curved section frictionally coupled with the first rotor, and a second curved section frictionally coupled with the second rotor;
a worm gear mechanism, including
a screw-threaded gear shaft pivotally disposed within the frame,
a turning means capable to rotate the gear shaft;
a screw-threaded bushing revolvably associated with the gear shaft as a screw pair,
a first half-shaft with an inner end fixedly coupled to said bushing, and an outer end slidely movable in relation to the frame;
a second half-shaft with an inner end fixedly coupled to said bushing, and an outer end slidely movable in relation to the frame, the half-shafts disposed in the same plane with and perpendicularly to the gear shaft;
a first roll revolvably mounted on the first half-shaft; and
a second roll revolvably mounted on the second half-shaft;
wherein the first branch extending below the first roll and brought into contact therewith, and, the second branch extending above the second roll and brought into contact therewith, so that said first roll capable to displace said first branch in a first direction, or alternatively said second roll capable to displace said second branch in a second direction parallel and oppositely oriented to the first direction, causing corresponding displacements Of the belt along the first direction or alternatively along the second direction, thereby changing planes of the belt's disposition, causing changes of the transmission ratio of said drive, and therefore controlling the RPM of the pump.

3. The variable speed drive according to claim 2, wherein said first and second rolls being performed as cylindrical ball-bearings of a predetermined size, inner-fixed to the corresponding half-shafts.

4. The variable speed drive according to claim 2, wherein said turning means being performed as an electric servomotor.

5. The variable speed drive according to claim 4, wherein said electric servomotor performed as a step-motor.

6. The variable speed drive according to claim 2, wherein said left and right half-shafts situated substantially in the same plane in which the belt is positioned.

7. The variable speed drive according to claim 2, wherein said left and right half-shafts situated in different levels above and under the plane in which the belt is positioned

8. The variable speed drive according to claim 1, wherein said revolvable device being a progressing cavity pump used to pump out fluid from a well, said variable speed drive further comprising:
a gauge measuring downhole pressure at the bottom of said well, and capable to issue reading signals proportional to the measured downhole pressure;
an automatic control unit capable to receive said reading signals from said gauge, and to issue regulative signals to said speed control means causing corresponding displacement of the left branch or the right branch, thereby changing the RPM of said pump; said automatic control unit configured to set
a time interval between two sequential said reading signals,
a rotational speed increment predetermined for said well, and
a threshold pressure for a fluid level above the progressing cavity pump;
wherein said automatic control unit operates cyclically as follows: upon receiving a first said reading signal, compares it to the threshold pressure; if the downhole pressure is equal to the threshold pressure, no regulative signal is issued; if the downhole pressure is less than the threshold pressure, said regulative signal is issued to decrease the RPM by the increment; if the downhole pressure is greater than the threshold pressure, said regulative signal is issued to increase the RPM by the increment, and thereafter said automatic control unit waits during said time interval for the next reading signal commencing the next cycle.
